(19) United States
(12) Patent Application Publication
(10) Pub. No.: US 2021/0330072 A1
(43) Pub. Date: Oct. 28, 2021

(54) COUNTERTOP EDGE EFFECT

(71) Applicant: Granix, Inc., Laurel, MD (US)

(72) Inventor: Ahmet Topcu, Laurel, MD (US)

(73) Assignee: Granix, Inc., Laurel, MD (US)

(21) Appl. No.: 16/856,300

(22) Filed: Apr. 23, 2020

(51) Int. Cl. A47B 13/08; A47B 77/02; B32B 27/38; B32B 9/00

(52) U.S. Cl. CPC A47B 13/08; A47B 77/022; B32B 27/38; B32B 2250/03; B32B 2315/02; B32B 2307/732; B32B 9/005

(57) ABSTRACT

A method of creating an edge effect for a countertop includes the steps of: cutting a first slab layer to a desired shape; applying a first epoxy resin layer to at least an outer edge portion of a bottom surface of the first slab layer; cutting a second slab layer; and attaching a second slab layer to a bottom surface of the first epoxy resin layer. The resulting edge of the countertop will comprise a striped design of slabs and epoxy. The invention allows for a thicker edge of a countertop with an aesthetically pleasing design.

### CROSS-REFERENCE

Not applicable.

### TECHNOLOGICAL FIELD

The present invention relates to countertops.

### BACKGROUND

Porcelain countertops are gaining popularity as stylish and durable countertops. However, porcelain countertops are limited to a small number of edge styles due to their relatively thin nature. Large format porcelain slabs typically range in thickness from six millimeters to twelve millimeters, yet the standard thickness for countertops in the United States is roughly thirty-two millimeters.

### BRIEF DESCRIPTION OF THE DRAWINGS

FIG. 1 is a cross-sectional perspective view of an embodiment of the present invention.

FIG. 2 is a cross-sectional perspective view of another embodiment of the present invention.

FIG. 3 is a schematic representation of a method according to an embodiment of the present invention.

### DETAILED DESCRIPTION

The present invention will now be described in more detail with reference to the accompanying drawings. The accompanying drawings show exemplary embodiments of the invention. The invention may, however, be embodied in many different forms and should not be construed as limited to the embodiments set forth herein.

An object of the present invention is to overcome the deficiencies in the prior art by providing a method for increasing the thickness of a porcelain countertop and creating a particular visual effect at the edge of the countertop.

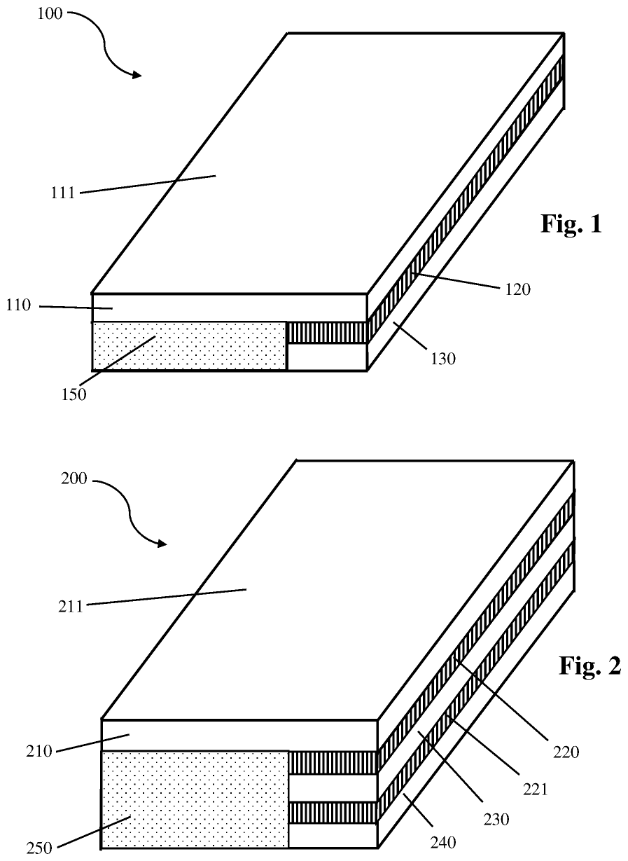

Referring to FIG. 1, a countertop assembly 100 may comprise a first slab layer 110, a first epoxy resin layer 120, and a second slab layer 130. The first slab layer 110 comprises a top surface 111 and a bottom surface. The first epoxy layer 120 may be applied to at least an outer edge portion of the bottom surface of the first slab layer. The second slab layer 130 may be attached to a bottom surface of the first epoxy resin layer. Alternatively, the first epoxy layer 120 may be applied to a top surface of the second slab layer 130 and the first slab layer 110 may be lowered onto a top surface the first epoxy layer 120. The first epoxy layer 120 and the second slab layer 130 may define substantially the same shape.

In an embodiment, the first slab layer 110 and the second slab layer 130 comprise porcelain. More specifically, in an embodiment, the first slab layer 110 and the second slab layer 130 may comprise large format porcelain slabs.

In an embodiment, the first slab layer 110 and the second slab layer 130 are each between five millimeters (5 mm) and fifteen millimeters (15 mm) thick. The first slab layer 110 and the second slab layer 130 may be of substantially equal thickness. In another embodiment, the first slab layer 110 and the second slab layer 130 may be of differing thicknesses.

In an embodiment, the first epoxy resin layer 120 is comprised of colored epoxy resin. The first epoxy resin layer 120 may also be uncolored.

In an embodiment, the countertop assembly 100 comprises an underlayment support 150. The underlayment support 150 may comprise cabinetry, kitchen appliances, bathroom fixtures, desks, or any other support structure on which a countertop may be placed. The first slab layer 110 may be laid upon the underlayment support 150 such that a top surface of the underlayment support contacts the bottom surface of the first slab layer.

In an embodiment, the underlayment support 150 is positioned against at least one wall in a room. For example, cabinets may span across a wall of a kitchen. Some edges of the first slab layer 110 may then contact the walls, while other edges do not contact a wall. The first epoxy resin layer 120 and the second slab layer 130 may be applied to the edges of the first slab layer 110 that would not contact a wall. In other words, the edge effect according to the present invention may be created on edges of a countertop that do not contact walls.

In another embodiment, the underlayment support 150 may comprise an island of cabinetry that does not contact any walls of a room. The first epoxy resin layer 120 and the second slab layer 130 may then be applied to all edges of the first slab layer 110 to create the edge effect according to the present invention along all edges of the countertop.

Referring now to FIG. 2, in another embodiment of the invention, a countertop assembly 200 comprises a first slab layer 210, a first epoxy resin layer 220, a second slab layer 230, a second epoxy resin layer 221, and a third slab layer 240. The first slab layer 210 comprises a top surface 211 and a bottom surface. The first epoxy layer 220 may be applied to at least an outer edge portion of the bottom surface of the first slab layer 210. The second slab layer 230 may be attached to a bottom surface of the first epoxy resin layer. The second epoxy resin layer 221 may be applied to a bottom surface of the second slab layer 230. The third slab layer 240 may be attached to a bottom surface of the second epoxy resin layer. Alternatively, the second epoxy resin layer 221 may be applied to a top surface of the third slab layer 240, the second slab layer 230 may be attached to a top surface of the second epoxy resin layer, the first epoxy resin layer 220 may be applied to a top surface of the second slab layer 230, and the first slab layer 210 may be lowered onto a top surface of the first epoxy layer 220. The first epoxy resin layer 220, the second slab layer 230, the second epoxy resin layer 221, and the third slab layer 240 may define substantially the same shape.

In an embodiment, the first slab layer 210, the second slab layer 230, and the third slab layer 240 may comprise porcelain. More specifically, in an embodiment, the first slab layer 210, the second slab layer 230, and the third slab layer 240 may comprise large format porcelain slabs.

In an embodiment, the first slab layer 210, the second slab layer 230, and the third slab layer 240 are each between five millimeters (5 mm) and fifteen millimeters (15 mm). The first slab layer 210, the second slab layer 230, and the third slab layer 240 may be of substantially equal thickness. In another embodiment, some or all of the first slab layer 210, the second slab layer 230, and the third slab layer 240 may be of differing thicknesses.

In an embodiment, the first epoxy resin layer 220 and the second epoxy resin layer 221 are comprised of colored epoxy resin. The first epoxy resin layer 220 and the second epoxy resin layer 221 may also be uncolored.

In an embodiment, the countertop assembly 200 comprises an underlayment support 250. The underlayment support 250 may comprise cabinetry, kitchen appliances, bathroom fixtures, desks, or any other support structure on which a countertop may be placed. The first slab layer 210 may be laid upon the underlayment support 150 such that a top surface of the underlayment support contacts the bottom surface of the first slab layer.

In an embodiment, the underlayment support 250 is positioned against at least one wall in a room. For example, cabinets may span across a wall of a kitchen. Some edges of the first slab layer 210 may then contact the walls, while other edges do not contact a wall. The first epoxy resin layer 220, the second slab layer 230, the second epoxy resin layer 221, and the third slab layer 240 may be applied to the edges of the first slab layer 210 that would not contact a wall. In other words, the edge effect according to the present invention may be created on edges of a countertop that do not contact walls.

In another embodiment, the underlayment support 250 may comprise an island of cabinetry that does not contact any walls of a room. The first epoxy resin layer 220, the second slab layer 230, the second epoxy resin layer 221, and the third slab layer 240 may then be applied to all edges of the first slab layer 210 to create the edge effect according to the present invention along all edges of the countertop.

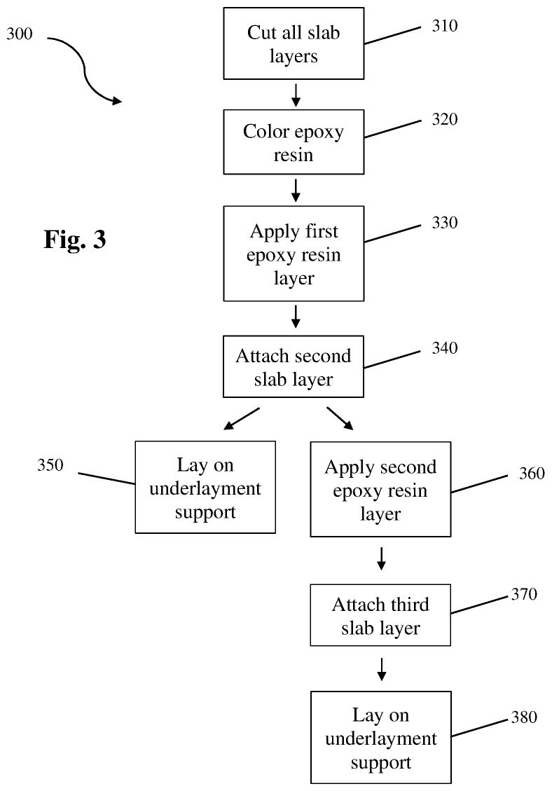

Referring now to FIG. 3, a representation 300 of creating an edge effect for a countertop is shown according to an embodiment. At step 310, all of the slab layers are cut to desired shapes. The slab layers may be cut from large format porcelain slabs. The slab layers may be between five millimeters (5 mm) and fifteen millimeters (15 mm) thick.

In an embodiment with two slab layers, the first slab layer and the second slab layer are cut at step 310. The second slab layer may be cut to a shape that can substantially cover the bottom surface of the first epoxy resin layer. The second slab layer may be of the same thickness as the first slab layer. The second slab layer may also have a different thickness than the first slab layer. In another embodiment, the second slab layer is cut after applying the first epoxy resin layer.

In an embodiment with three slab layers, the first slab layer, the second slab layer, and the third slab layer are cut at step 310. The second slab layer may be cut to a shape that can substantially cover the bottom surface of the first epoxy resin layer, and the third slab layer may be cut to a shape that can substantially cover the bottom surface of the second epoxy resin layer. The second slab layer may be cut to a shape that can substantially cover the bottom surface of the first epoxy resin layer. The second slab layer may be of the same thickness as the first slab layer. The second slab layer may also have a different thickness than the first slab layer. The third slab layer may be of the same thickness as the first and second slab layers. The third slab layer may also have a different thickness than the first and second slab layers. In another embodiment, the second slab layer is cut after applying the first epoxy resin layer and the third slab layer is cut after applying the second epoxy resin layer. Additional slab layers may also be cut at step 310 if a thicker edge effect is desired.

In an embodiment, at step 320, epoxy resin may be colored to a desired color. In another embodiment, the epoxy resin may be left uncolored.

In an embodiment, at step 330, the first epoxy resin layer is applied to at least an outer edge portion of a bottom surface of the first slab layer.

In an embodiment, at step 340, the second slab layer is attached to the bottom surface of the first epoxy resin layer.

In an embodiment, at step 350, the countertop may then be laid upon an underlayment support.

Alternatively, in another embodiment, at step 360, a second epoxy resin layer is applied to the bottom surface of the second slab layer. The second epoxy resin layer may substantially cover the bottom surface of the second slab layer.

In an embodiment, at step 370, the third slab layer is attached to the bottom surface of the second epoxy resin layer.

In an embodiment, at step 380, the countertop may then be laid upon an underlayment support.

In another embodiment, the second epoxy resin layer may be applied to a top surface of the third slab layer, the second slab layer may be attached to a top surface of the second epoxy resin layer, the first epoxy resin layer may be applied to a top surface of the second slab layer, and the first slab layer may be lowered onto a top surface of the first epoxy layer.

The resulting edge of the countertop will visually comprise a striped design of slabs and epoxy. The invention allows for a thicker edge of a countertop with an aesthetically pleasing design. The figures show one edge of a countertop, but the edge effect according to the present invention may continue around all outside edges of the countertop. The method of the present invention may also be used to create an edge effect on a countertop of any shape.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved countertop assemblies.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims.

What is claimed is:

1. A method of creating an edge effect for a countertop, the method comprising the steps of:
cutting a first slab layer to a desired shape;
cutting a second slab layer;
applying a first epoxy resin layer to at least an outer edge portion of a bottom surface of the first slab layer; and
attaching the second slab layer to a bottom surface of the first epoxy resin layer.

2. The method of claim 1, wherein at least one of the first slab layer and the second slab layer comprise porcelain.

3. The method of claim 1, wherein the first slab layer and the second slab layer are each between five millimeters (5 mm) and fifteen millimeters (15 mm).

4. The method of claim 3, wherein the first slab layer and the second slab layer are of substantially equal thickness.

5. The method of claim 3, wherein the first slab layer and the second slab layer are of differing thicknesses.

6. The method of claim 1, further comprising the step of coloring the epoxy resin layer.

7. The method of claim 1, further comprising the step of laying the countertop on an underlayment support, wherein a top surface of the underlayment support contacts the bottom surface of the first slab layer.

8. The method of claim 1, further comprising the steps of:
applying a second epoxy resin layer to a bottom surface of the second slab layer;
cutting a third slab layer; and
attaching the third slab layer to a bottom surface of the second epoxy resin layer.

9. The method of claim 8, wherein the third slab layer comprises porcelain.

10. The method of claim 8, wherein the third slab layer is between five millimeters (5 mm) and fifteen millimeters (15 mm).

11. The method of claim 8, further comprising the step of coloring the second epoxy resin layer.

12. The method of claim 8, further comprising the step of laying the countertop on an underlayment support, wherein a top surface of the underlayment support contacts an inner portion of the bottom surface of the first slab layer.
